(19) United States
(12) Patent Application Publication
(10) Pub. No.: US 2013/0205867 A1
(43) Pub. Date: Aug. 15, 2013

(54) Automatic rectifying system for machine tools

(71) Applicant: Rock Liao, Taipei City (TW)

(72) Inventor: Rock Liao, Taipei City (TW)

(73) Assignee: QUASER MACHINE TOOLS, INC.

(21) Appl. No.: 13/371,071

(22) Filed: Feb. 10, 2012

(51) Int. Cl. G01P 21/00

(52) U.S. Cl. 73/1.79

(57) ABSTRACT

An automatic rectifying system for machine tools includes a carrier platform, a contact type probe, a control device and a driving mechanism. The carrier platform may carry a work piece and a calibrator. The contact type probe is fitted to a main axle. In use, the contact type probe may touch the calibrator. The position of the calibrator corresponds to at least a trigger parameter so as to define a reference point. Such trigger parameter is fed to the control device. Then, the control device generates a control signal. Next, the control signal is fed to the driving mechanism, which in turn may move the carrier platform to offset the displacements or deviations of the carrier platform.

### BACKGROUND OF THE INVENTION

1. Field of the Invention

The invention generally relates to an automatic rectifying system. More particularly, the invention relates to an automatic rectifying system used for machine tools, in which the displacements or deviations of the carrier platform may be offset.

2. Description of the Prior Art

Before a NC (numerical control) machine tool carries out cutting/shearing process, it must be “homed” or “zeroed” and measurements have to be made to eliminate the displacements.

Traditionally, a probe, which is fitted to the main axle, is used to touch a square-shaped fixture disposed on the carrier platform to obtain the coordinates and the corresponding displacements. In actual practice, to save time, a user moves the probe towards the fixture and uses a hand-wheel to manually manipulate and move the probe around to obtain the relevant data. Then, an operator manually inputs these data so as to rectify the position of the fixture.

Because the operator has to uses the hand-wheel to gradually move the probe around, such method is time-consuming. In addition, the accuracy of such manipulation may be affected by poor eyesight. Moreover, because the operator has to input these data manually, an error in the calculation or data-taking may result in an error in the numerical values of the displacements. Furthermore, the operator may accidentally press a wrong button in the input of the data and this may lead to a disaster and raise the non-forming rate.

Therefore, such manual method to offset the displacements needs to be improved so as to achieve the goal of high precision and high efficiency.

### SUMMARY OF THE INVENTION

An object of the present invention is to provide an automatic rectifying system, which can swiftly measure and calculate the positions and displacements of the carrier platform and input the displacements so as to save time and eliminate the errors in data input.

Another object of the present invention is to provide an automatic rectifying system, which can swiftly detect and rectify the displacements of the carrier platform through the contact between a probe and a calibrator so as to save time.

Still another object of the present invention is to provide an automatic rectifying system, in which the positions of a calibrator relative to a reference point may be swiftly measured.

To reach these objects, the automatic rectifying system of the present invention is disclosed. The automatic rectifying system of the present invention comprises:
a carrier platform, which can move in several directions and can carry a work piece and a calibrator;
a contact type probe, which is fitted to a main axle, wherein the calibrator is moved to touch the contact type probe, and wherein the contact type probe can measure the position of the calibrator and such position corresponds to at least a trigger parameter so as to define a reference point;
a control device, which can receive a trigger parameter and then generate a control signal, wherein the control device can control the movements of the carrier platform according to such control signal so as to rectify the position of the carrier platform; and
a driving mechanism, which can move the carrier platform in the three linear directions and two rotational directions so as to offset the displacements of the carrier platform.

### BRIEF DESCRIPTION OF THE DRAWINGS

The drawings disclose an illustrative embodiment of the present invention which serves to exemplify the various advantages and objects hereof, and are as follows:

FIG. 1 is an overall perspective view of the automatic rectifying system of the present invention.

FIG. 2 is a partially enlarged view of the area marked by “A” in FIG. 1.

FIG. 3 is a view illustrating that the driving mechanism moves the carrier platform so that the calibrator may be vertically aligned with the probe.

FIG. 4 is a partially enlarged view of the area marked by “B” in FIG. 3.

FIG. 5 is a side view illustrating that the calibrator approaches the probe for the probe.

FIG. 6 is a side view illustrating that the calibrator touches the probe so that the probe may measure the top point (the first point) of the calibrator.

FIGS. 7 and 8 are a side view and a top view, respectively, illustrating that the calibrator approaches the probe so that the probe may measure the coordinates of the 3-o'clock point/location (the second point/location) of the calibrator.

FIG. 9 is a top view illustrating that the calibrator touches the probe so that the probe may measure the coordinates of the 3-o'clock point (the second point) of the calibrator.

FIG. 10 is a top view illustrating that the calibrator touches the probe so that the probe may measure the coordinates of the 12-o'clock point (the third point) of the calibrator.

FIG. 11 is a top view illustrating that the calibrator touches the probe so that the probe may measure the 9-o'clock point (the fourth point) of the calibrator.

FIG. 12 is a top view illustrating that the calibrator touches the probe so that the probe may measure the 6-o'clock point (the fifth point) of the calibrator.

### DETAILED DESCRIPTION OF THE PREFERRED EMBODIMENT

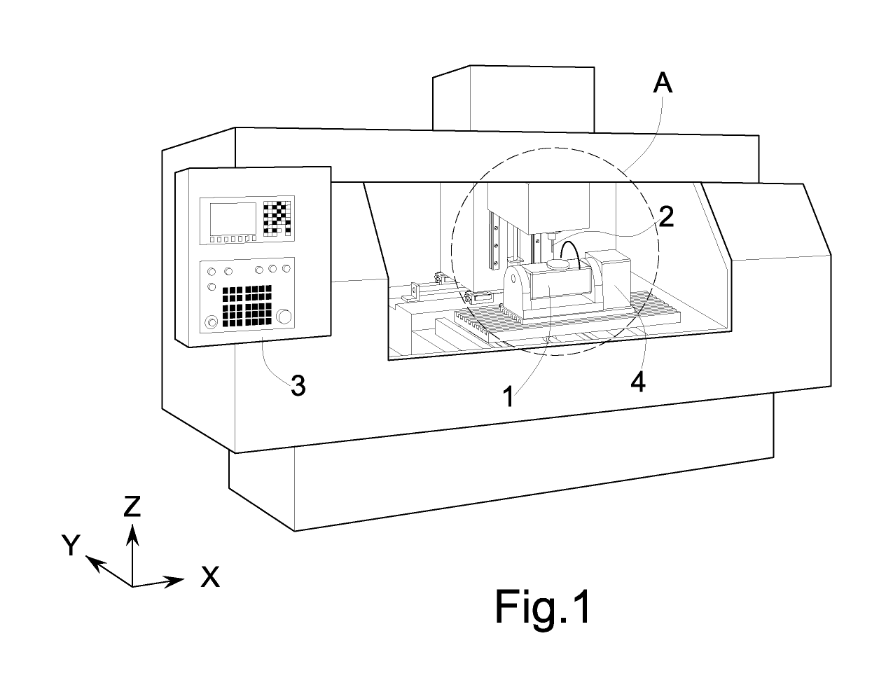

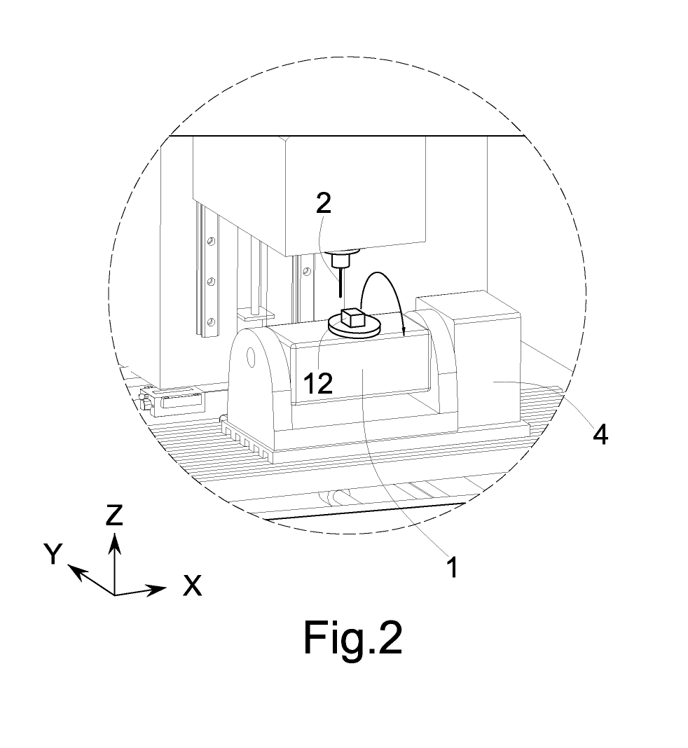

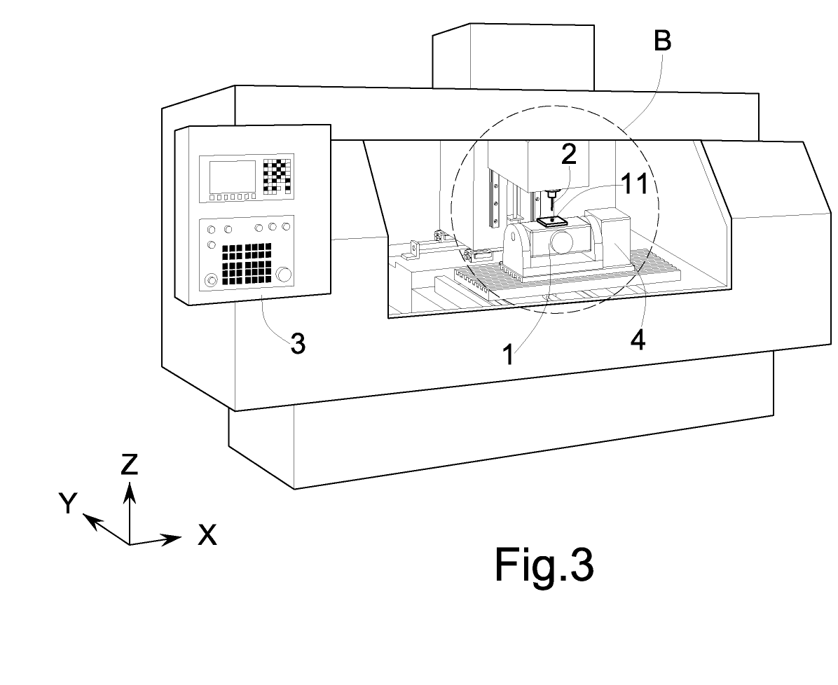

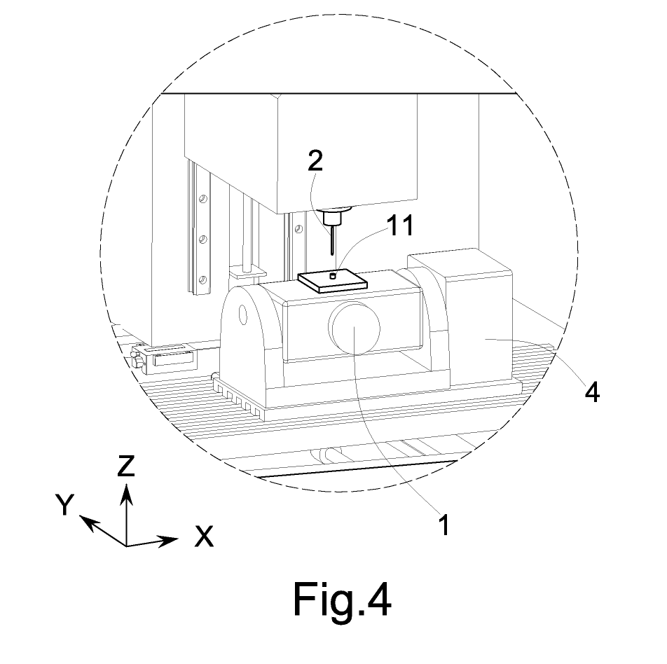

Please refer to FIGS. 1 to 4. The automatic rectifying system of the present invention comprises a carrier platform 1, a contact type probe 2, a control device 3 and a driving mechanism 4.

The carrier platform 1 may carry a work piece 12 and a calibrator 11. The calibrator 11 is disposed on the carrier platform 1, which can move in the X, Y, Z, A and B directions.

The contact type probe 2 is fitted to a main axle 21 and may move towards the calibrator 11. The original position of the calibrator 11 corresponds to at least a trigger parameter so as to define a reference point.

After the control device 3 receives such trigger parameter which is indicative of the contact between the contact type probe 2 and the calibrator 11, the control device 3 sends out a control signal to move the carrier platform 1.

The control device 3 sends out a control signal to the driving mechanism 4, which in turn moves the carrier platform 1 in the X, Y and Z directions and the two rotational directions so as to automatically offset for the displacements of the carrier platform 1.

The carrier platform 1, which can move in the X, Y and Z directions and the two rotational directions, is disposed on the machine tool. The machine tool is provided with the main axle 21. At least a clip, which can fixedly hold a work piece, and the calibrator 11 are provided on the carrier platform 1. The carrier platform 1 may be moved via manual control or programmable control so that the calibrator 11 may be vertically aligned with the main axle 21. In use, several types of cutting implements may be chosen from; either a cutting implement or the contact type probe 2 may be fitted to the main axle 21. The contact type probe 2 is electrically conductive. When the contact type probe 2 touches the perimeter or the top surface of the calibrator 11, a trigger parameter may be generated.

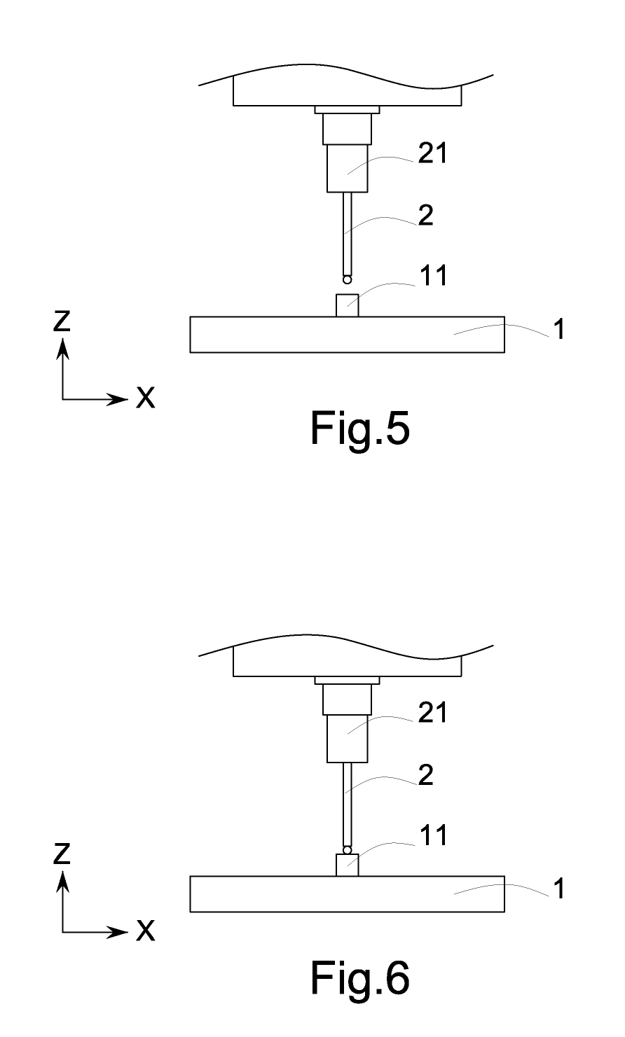

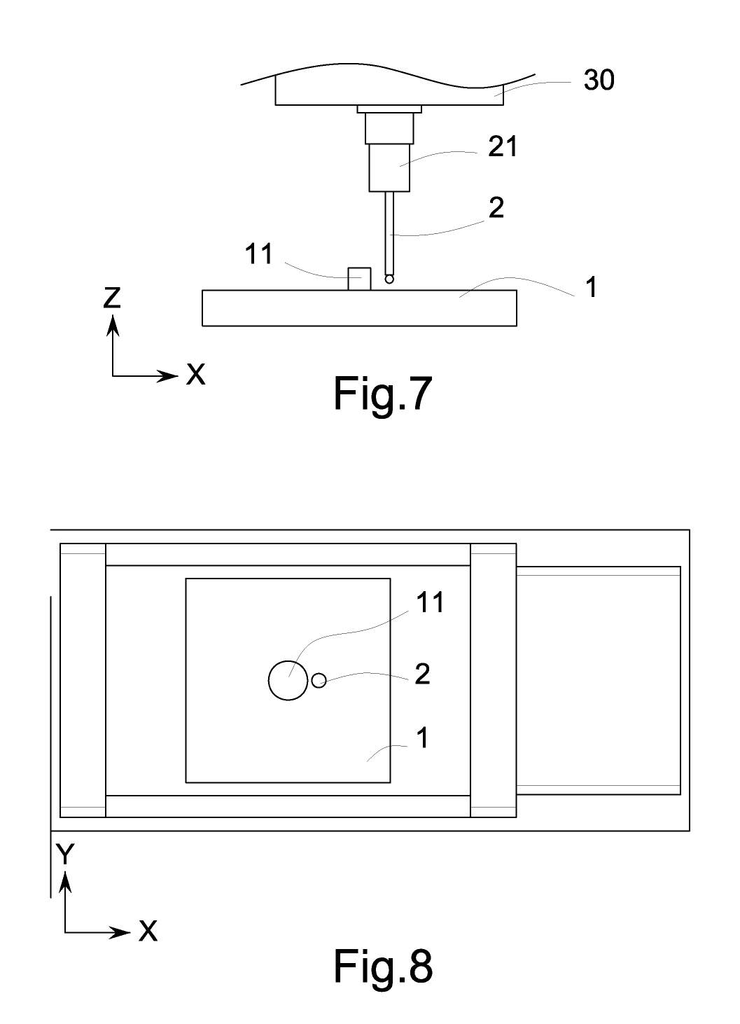

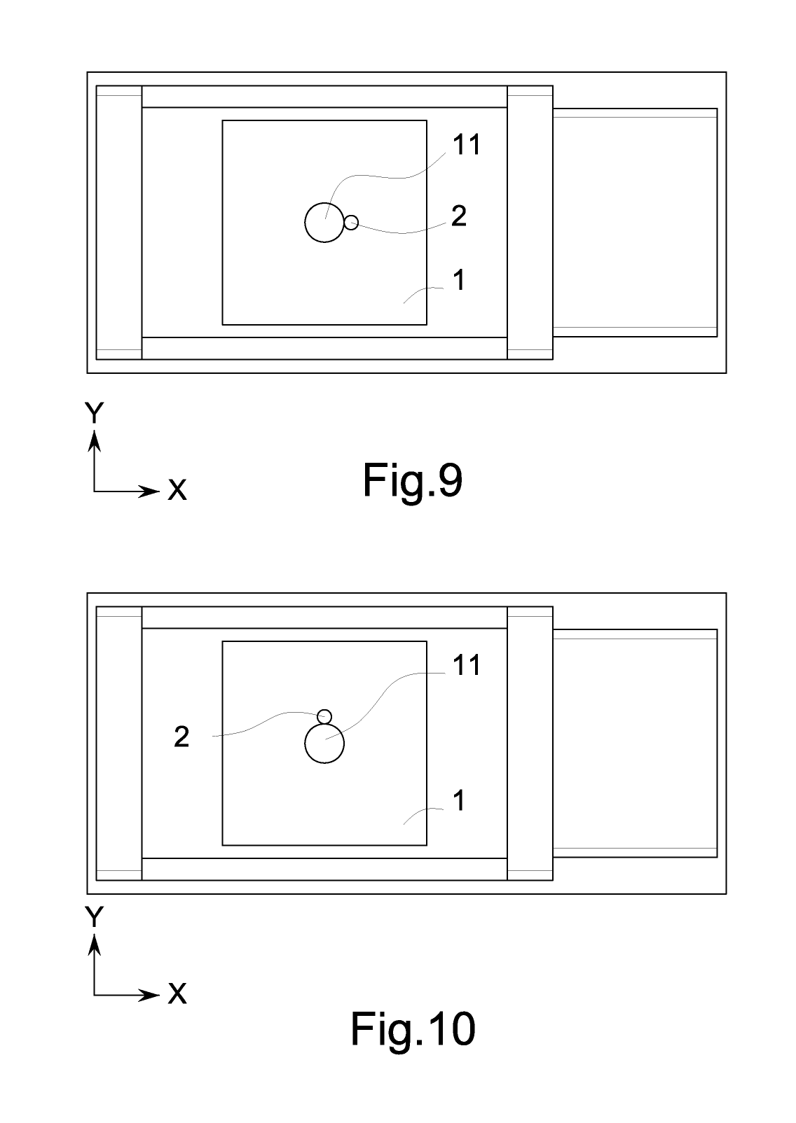

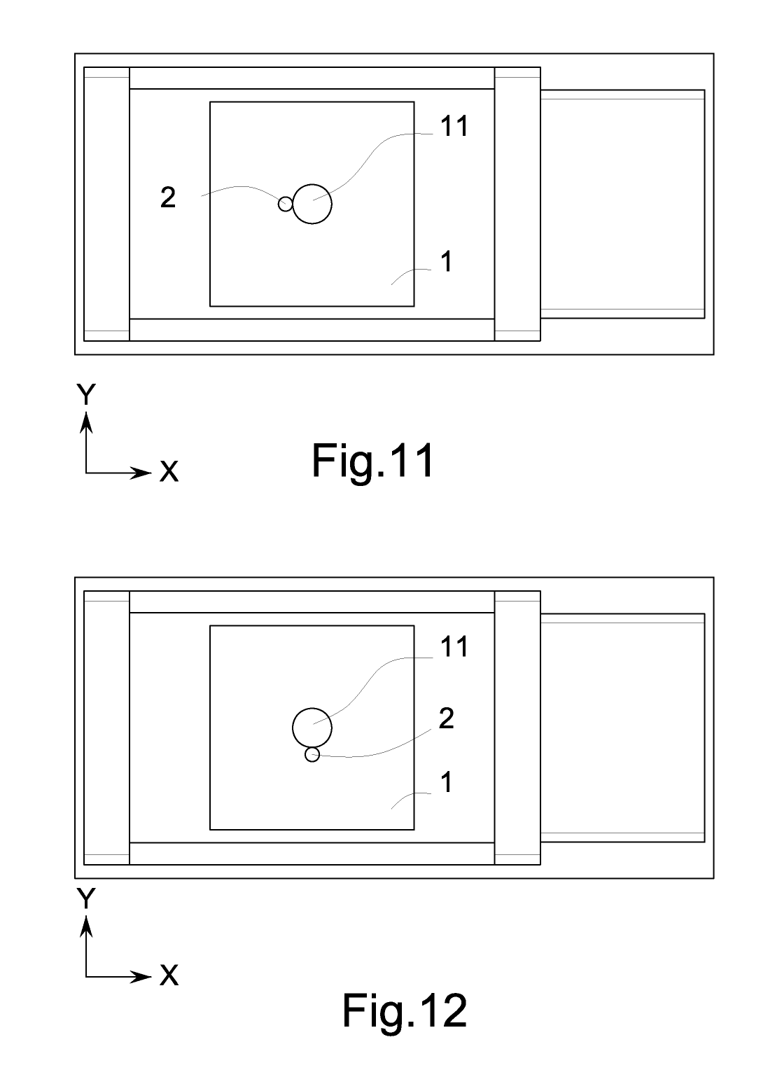

Please see FIGS. 5 to 12 for how the measurements are carried out. (1) First, the probe 2 is moved from a known position towards the calibrator 11 and rests on top of the calibrator 11. (2) Then, the probe 2 moves towards one edge and then other three edges of the calibrator 11. (3) The probe 2 moves to and detects and acquires the coordinates of the five points (top point, 3-o'clock point, 12-o'clock point, 9-o'clock point and 6-o'clock point) of the calibrator 11. (4) After each point's coordinates are measured, a trigger parameter is generated. (5) Then, the probe 2 stops moving around the perimeter of the calibrator 11. (6) The control device 3, which is electrically connected with the contact type probe 2, may determine the coordinates of the five points according to the five generated trigger parameters with respect to each of the five points. (7) Then, the control device 3 compares the new coordinates of the five points with the original coordinates of the five points to determine the displacements and then sends out a control signal to move the driving mechanism 4 so as to offset the displacements of the carrier platform 1.

The reference point of the cutting implement is acquired before the cutting process is carried out on the work piece 12. First, the probe should be fitted to the main axle. The calibrator 11 is disposed on the carrier platform 1. The contact type probe 2 is located above the carrier platform 1. Then, the driving mechanism 4 moves the carrier platform 1 towards the probe 2 so that the calibrator 11 may touch the probe 2. When the contact type probe 2 touches the calibrator 11, the control device 3 can record the coordinates of the first point, second point, third point, fourth point and fifth point of the calibrator 11.

In the cutting process, displacements occur on the carrier platform 1 because the carrier platform 1 moves in the X, Y and Z directions and the two rotational directions in the process. The control device 3 may carry out programmable measurements, which allows the contact type probe 2 to carry out such measurements in the cutting process (the cutting implement has to be replaced by the probe). The control device 3 can determine and output the displacements at the first to fifth points.

Then, the control device 3 compares the position data with the displacement data so as to determine when and how to move the driving mechanism 4 to automatically offset these displacements. Therefore, we can program the control device 3 to move the main axle 21 and the driving mechanism 4 to trace the perimeters and then offset the displacements or deviations. In this manner, perimeter-tracing may be carried out swiftly, human errors may be avoided and displacements may be offset.

Many changes and modifications in the above described embodiment of the invention can, of course, be carried out without departing from the scope thereof. Accordingly, to promote the progress in science and the useful arts, the invention is disclosed and is intended to be limited only by the scope of the appended claims.

What is claimed is:

1. An automatic rectifying system for machine tools, comprising:
a carrier platform, which can move in several directions and can carry a work piece and a calibrator;
a contact type probe, which is fitted to a main axle and may move towards the calibrator, wherein the contact type probe can measure the position of the calibrator and such position corresponds to at least a trigger parameter so as to define a reference point;
a control device, which can receive the trigger parameter and then generate a control signal, wherein the control device can control the movements of the carrier platform according to such control signal so as to rectify the position of the carrier platform; and
a driving mechanism, which can move the carrier platform in the three linear directions and two rotational directions so as to offset the displacements of the carrier platform.

2. The automatic rectifying system as in claim 1, wherein the measurements are carried out according to the following steps:
(1) the probe being moved around the perimeter of the calibrator, wherein the probe is moved from a known position towards the calibrator and rests on top of the calibrator;
(2) the probe moving towards one edge of the calibrator;
(3) the probe moving to and detecting five points (top point, 3-o'clock point, 12-o'clock point, 9-o'clock point and 6-o'clock point) of the calibrator;
(4) after each point's coordinates being measured, a trigger parameter being generated;
(5) the probe stoping moving around the perimeter of the calibrator;
(6) the control device, which is electrically connected with the contact type probe, determining the coordinates of the five points according to the five generated trigger parameters with respect to each of the five points; and
(7) the control device comparing new coordinates of the five points with original coordinates of the five points to determine the displacements and then sending out a control signal to move the driving mechanism so as to offset the displacements of the carrier platform.

3. The automatic rectifying system as in claim 1, wherein the carrier platform moves towards the contact type probe so that the calibrator can touch the probe.

4. The automatic rectifying system as in claim 2, wherein when the contact type probe touches the calibrator, the control device can record the coordinates of the first to fifth points of the calibrator.

5. The automatic rectifying system as in claim 2, wherein the control device can carry out programmable measurements, which allows the contact type probe to carry out measurements in the cutting process, and the control device can determine and output the displacements or deviations at the first to fifth points.
